(19) United States
(12) Patent Application Publication
(10) Pub. No.: US 2016/0378574 A1
(43) Pub. Date: Dec. 29, 2016

(54) INTEGRATION AND SYNCHRONIZATION USING A VIRTUAL DATA PROVIDER

(71) Applicant: Microsoft Technology Licensing LLC, Redmond, WA (US)

(72) Inventors: Thomas Hejlsberg, Horsholm (DK); Esben Nyhuus Kristoffersen, Dyssegaard (DK); Steffen Balslev, Hillerod (DK); Jens Møller-Pedersen, Copenhagen (DK); Jesper Falkebo, Copenhagen (DK); Rikke Pernille Hagen Lassen, Copenhagen (DK); Marc Hansen, Vedbeak (DK)

(21) Appl. No.: 14/747,750

(22) Filed: Jun. 23, 2015

(51) Int. Cl. G06F 9/54; G06F 17/30

(52) U.S. Cl. CPC G06F 9/54; G06F 17/30569; G06F 17/30575

(57) ABSTRACT

A data access request for data that is provided from a data provider corresponding to an external data source. The data access request is transformed into a call supported by the external computing system. Data that is responsive to the call is received in a form provided by the external computing system, and the data is transformed into a form expected by the native system. The transformed data is returned to the requestor through the API.

### BACKGROUND

Computer systems are currently in wide use. Some computer systems communicate with one another using data that is in different forms.

When computing systems communicate with one another, it is often desirable to have data synchronized between the two systems. Synchronizing data from different solutions can be difficult.

For instance, some synchronization systems identify one computing system as the master of the data, and the other computing system as including data that is derived from the master. However, even when this is the case, synchronizing data in databases across two or more solutions can be a relatively complicated process. Problems can be exacerbated by the fact that the fields describing data in the two different databases may be somewhat different.

For example, it may be that a first computing system might represent an entity, such as a customer, with three address fields. Another computing system, however, which communicates with the first computing system, may represent the same entity (e.g., a customer entity) using only two address fields. This can present problems.

Some current systems attempt to synchronize the two systems by imposing a variety of different restrictions. For instance, some current systems require there to be a one-to-one mapping between schemas in the two systems. That is, it may require both computing systems to have two address fields for the customer entity, instead of three. In a system in which, one of the computing systems is designated as the master, the other may be restricted to only looking up data. In this type of system, offline functionality is often very limited. It may, in fact, be limited to read only functionality.

Synchronization conflicts are also relatively troublesome. For instance, they can require human intervention, which is costly and time consuming, and can prevent automation of certain operations.

Further, many such computer systems are customized, and often heavily customized, before being finally implemented at an end user organization. This can exacerbate the synchronization problem.

The discussion above is merely provided for general background information and is not intended to be used as an aid in determining the scope of the claimed subject matter.

### SUMMARY

A data access request in a first computing system requests data that is provided from a data provider corresponding with an external computing system. The data access request is received through an application programming interface (API) on the first computing system and is transformed into a call supported by the external computing system. Data that is responsive to the call is received in a form provided by the external computing system, and the data is transformed into a form expected by the first computing system. The transformed data is returned to a requestor through the API.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one example of a computing system architecture that uses a virtual data provider.

FIGS. 2A and 2B (collectively referred to as FIG. 2) show a flow diagram illustrating one example of the operation of the architecture shown in FIG. 1, in providing data from an external computing system.

FIG. 3 is a flow diagram illustrating one example of the operation of the architecture shown in FIG. 1, in synchronizing data between the two computing systems.

FIG. 4 is a block diagram illustrating the architecture depicted in FIG. 1, but deployed in a cloud computing architecture.

FIGS. 5-7 show examples of mobile devices that can be used in the architectures depicted in the previous figures.

FIG. 8 is a block diagram of one example of a computing environment that can be used in the architectures depicted in the previous figures.

### DETAILED DESCRIPTION

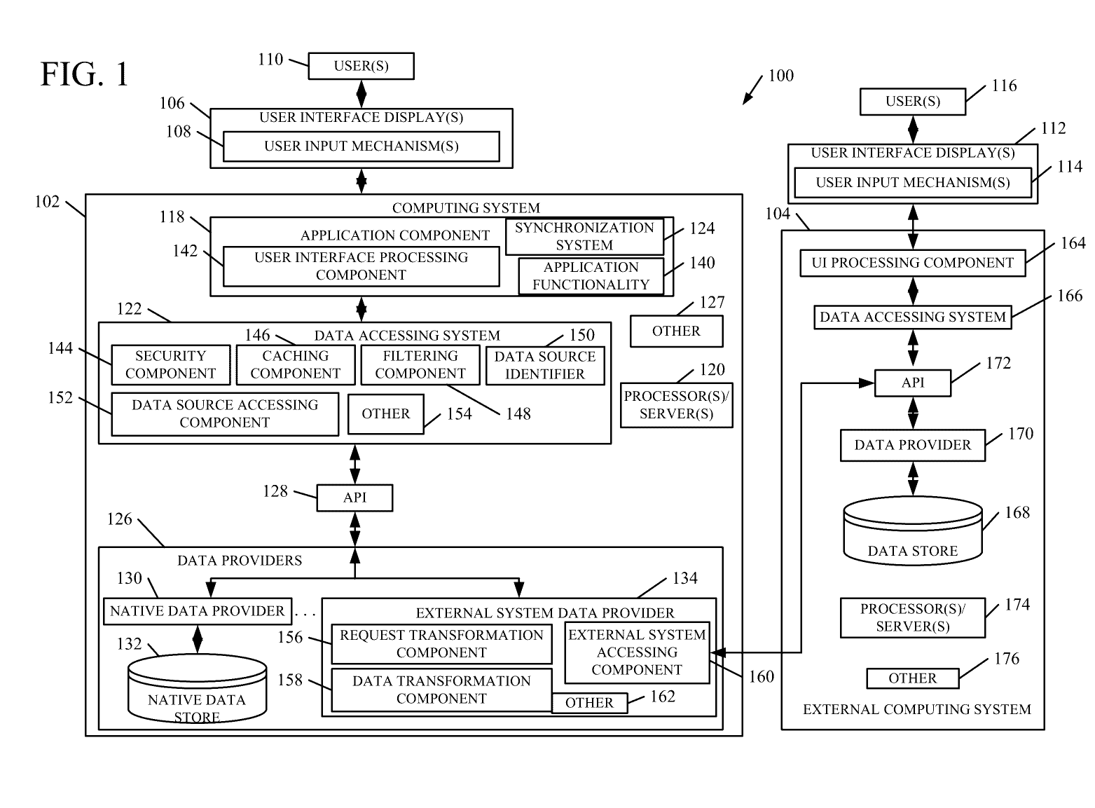

FIG. 1 is a block diagram of one example of a computing system architecture 100. Architecture 100 includes computing system 102 and computing system 104. Computing system 102 illustratively generates a set of user interface displays 106, with user input mechanisms 108, for interaction by one or more users 110. Users 110 illustratively interact with user input mechanisms 108 in order to control and manipulate computing system 102.

Computing system 104 is shown generating user interface displays 112, with user input mechanisms 114, for interaction by one or more users 116. Users 116 illustratively interact with user input mechanisms 114 in order to control and manipulate computing system 104.

In the example shown in FIG. 1, computing system 104 is referred to as an external computing system. This is because it is external to (and perhaps remote from) computing system 102. However, computing systems 102 and 104 illustratively access data from one another so that data can be presented for interaction by their corresponding users 112 and 116. Therefore, in one example, for instance, computing system 102 may be an enterprise resource planning system while computing system 104 is a customer relations management system. Both systems may have data records (e.g., entities or other records) that represent items within the two computing systems, respectively. For instance, computing system 102 may have a set of product entities, each of which represents and describes a product of the organization using computing system 102. Similarly, external computing system 104 may have product entities that represent and describe products in the same organization. In that scenario, computing systems 102 and 104 are used by the same organizations, but they are separate computing systems and may be used for different purposes. They may, however, be computing systems in different organizations. In either case, they illustratively have data records that represent similar things. By way of example, both systems may have a customer record (or entity) that describes and defines a customer. This is just one example of the types of data that might be maintained by computing systems 102 and 104.

Because the computing systems are separate systems, the records that represent the data may not be the same in terms of their structure or schema. For instance, it may be that a customer record in computing system 102 has two address fields, but a customer record in computing system 104 has three address fields. Therefore, when one of the computing systems accesses a customer record in the other computing system, this can be problematic, because the schemas or data structures representing the customers in the two computing systems differ from one another.

Therefore, by way of overview, computing system 102 illustratively provides a virtual data provider (which will be described in greater detail below) at a relatively low level in the processing stack of the computing system. The virtual data provider accesses data from computing system 104, and transforms it into a schema or data structure that is expected by the upper level processing elements of computing system 102. Therefore, computing system 102 can act on the data from computing system 104 as if it were its own, native data. Similarly, the virtual data provider in computing system 102 provides its native data to computing system 104 according to a schema or data structure that is expected by computing system 104. Thus, computing system 104 can access data in computing system 102 and use it, as if it were its own, native data. Also, in one example, all synchronization operations are performed on one of the computing systems (in this case, computing system 102).

FIG. 1 will now be described in more detail. Computing system 102 illustratively includes application component 118, processors or servers 120, data accessing system 122, a set of data providers 126 and it can include other items 127. Data providers 126 expose a common set of application programming interfaces (APIs) 128. Data providers 126 illustratively include one or more native data providers 130 that provide access to native data in one or more native data stores 132. Data providers 126 also illustratively include one or more external system data providers (or virtual data providers) 134 that provide access to data in a corresponding external system (such as external system 104). Thus, as mentioned above, external system data provider 134 exposes the same common API 128 for interaction by data accessing system 122 in computing system 102 as does the native data provider 130.

In the upper level processing components, application component 118 illustratively includes application functionality 140, synchronization system 124 and user interface processing component 142. Data accessing system 122 can illustratively include a wide variety of components for performing various processing steps on data. For instance, it can include security component 144, that manages security of data accessed by other upper level components in computing system 102. It can include caching component 146 that manages caching of data. It can include filtering component 148 that manages filtering of data. It can include data source identifier 150 that identifies a particular data source (e.g., data provider 126) to be interacted with, based upon a call for data. It can include data source accessing component 152 that uses APIs 128 to access data from the various data providers, and it can include other items 154.

External system data provider 134 illustratively includes request transformation component 156, data transformation component 158, external system accessing component 160, and it can include other items 162.

External computing system 104 illustratively includes user interface (UI) processing components 164 that manage user interface operations in computing system 104. System 104 also illustratively includes a data accessing system 166 that accesses data stored in data store 168, through a data provider 170. Data provider 170 illustratively exposes API 172 for interaction by data accessing system 166. External computing system 104 can include a set of processors or servers 174, and it can include a wide variety of other items 176.

Therefore, (and continuing with the overview), external data provider 134 exposes (on the side facing the upper level components of computing system 102) the common API 128. On the side facing external computing system 104, it interacts through API 172. Therefore, request transformation component 156 receives a request from data accessing system 122 to retrieve data from, or send data to, data store 168 in external computing system 104. It transforms that request into a request consistent with API 172, and external system accessing component 160 interacts with API 172 to either retrieve the data from data store 168 (through data provider 170) or to store data to data store 168 (through data provider 170).

Data transformation component 158 transforms the data to the appropriate structure. Therefore, when data is retrieved by data accessing system 122, from data store 168, data transformation component 158 transforms the retrieved data into the form expected by API 128. This may involve relatively low level transformations such as a precision with which numbers are stored, collation of strings, etc. Similarly, when data accessing system 122 provides data to be stored on data store 168, data transformation component 158 transforms that data into the structure expected by API 172.

Synchronization system 124 illustratively performs synchronization operations to keep the data between the two computing systems 102 and 104 in sync with one another. In one example, synchronization system 124 is implemented in, or called by, application code. This allows developers who customize applications to also take care of conversions or transformations. For instance, if external computing system 104 stores a customer entity with an external schema that has two address fields, but computing system 102 stores the customer entity with a native schema that has three address fields, then synchronization system 124 transforms the retrieved data into a record with three address fields. In another example, it may be that computing system 102 keeps a set of tables in native data store 132, that store information from external computing system 104. By way of example, it may be that external computing system 104 includes a set of “opportunity” or “lead” entities that are stored in tables in data store 168. It may be that computing system 102 duplicates those tables in native data store 132, but in the structure that is expected by computing system 102, instead of in the structure expected by computing system 104. In that case, synchronization system 124 will intermittently call (through data accessing system 122 and API 128) for the data from those tables in data store 168, through external system data provider 134. Data transformation component 158 transforms that table data into the form expected by computing system 102, and synchronization system 124 synchronizes the data to native data store 132.

When a user of computing system 102 makes an authorized change to that data, the synchronization system 124 makes a call through data accessing system 122 and API 128 to store the changes to data store 168 in external computing system 104. Similarly, when synchronization system 124 detects that a change has been made to those tables in data store 168, it again calls for that data and synchronizes the changes to the corresponding data in native data store 132.

In doing so, synchronization system 124 not only detects when changes have been made, but it also detects when conflicting changes occur. It can automatically resolve conflicts or surface conflicts for human resolution, or it can resolve conflicts in both ways, where some conflicts are automatically resolved and others are surfaced for human resolution. By way of example, synchronization system 124 can have a set of conflict resolution rules that it uses to automatically resolve some conflicts. The conflict resolution rules can be written, as desired by a developer or otherwise. The conflict resolution rules may also indicate when a certain conflict or set of conflicts is to be surfaced for manual resolution. Of course, this is only one example of how synchronization system 124 can resolve conflicts.

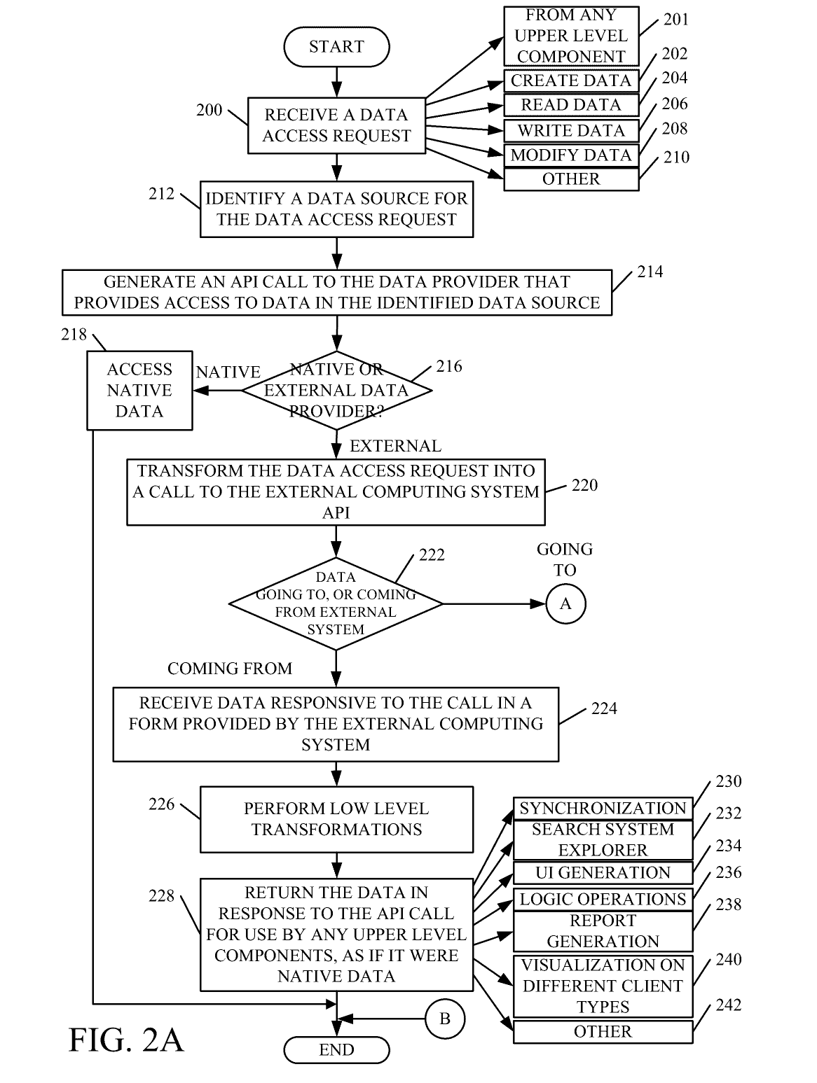

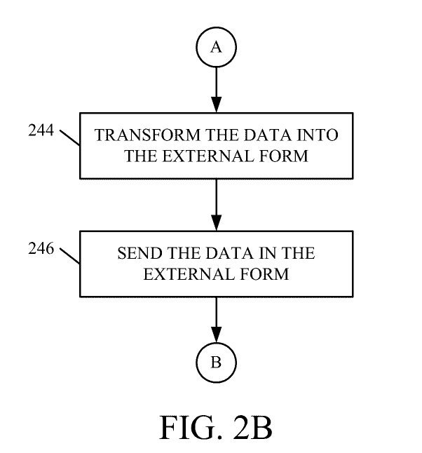

FIGS. 2A and 2B (collectively referred to as FIG. 2) show a flow diagram illustrating one example of the operation of architecture 100 in more detail. It is first assumed that external system data provider 134 has indicated to data accessing system 122 (and particularly data source identifier 150) that it is a data access provider that provides access to data from external computing system 104. This can be done in a variety of different ways. For instance, external system data provider 134 can interact with data source identifier 150 through API 128 to identify the particular data that it provides access to. This can be logged or otherwise maintained by data source identifier 150. It can also register with data accessing system 122, or an operating system of computing system 102 in other ways as well. In any case, it is assumed that data source identifier 150 will identify that external system data provider 134 provides access to data in external computing system 104.

Data accessing system 122 receives a data access request. This is indicated by block 200. The request can be from an upper level computing system component in computing system 102 (such as synchronization system 124, an explorer, a UI processing component 142, another application function 140, etc.). This is indicated by block 201. System 122 can also generate a data access request itself. The data access request can be a request to create data 202, to read data 204, to write data 206, to modify data 208, or another type of request 210. Regardless of the source of the data to which access is requested, the request is in a form as if the data was stored in a native table that is native to system 102.

Data source identifier 150 then identifies the source for the data access request. This is indicated by block 212. For instance, it can identify whether the data access request is for native data stored in native data store 132. In that case, it will identify native data store provider 130 as the target for the data access request. It can also identify whether the data access request is for external data stored in data store 168 of computing system 104. If so, it will identify external system data provider 134 as the target of the data access request. It will also be noted that if the data access request is for external data in data store 168, then synchronization system 124 (or another upper level computing system component) has transformed the request, as needed. For instance, if the data access request is to write data to a record in data store 168, then synchronization system 124 will perform any transformations needed to ensure that the data provided conforms to the external schema or structure of the record in data store 168 (e.g., system 124 may add a third address field, etc.).

Once the data source is identified, data source accessing component 152 illustratively generates an API call using API 128 to the data provider that provides access to data in the identified data source. This is indicated by block 214. Again, for instance, if the data access request is to access data that is kept in external computing system 104, then the API call will be made to external system data provider 134. If it is for native data stored in data store 132, then the API call will be made to native data provider 130. This is indicated by block 216.

If the data access request is for native data stored in data store 132, then native data provider 130 simply provides access to the native data. For instance, it can return requested data from data store 132, store data on data store 132, modify data, etc. This is indicated by block 218.

If data source identifier 150 identifies the data source corresponding to the data access request to be an external data provider 134, then request transformation component 156 transforms the data access request so that it is compatible with API 172. This is indicated by block 220 in FIG. 2. It may be that an extra data transformation is needed also.

Therefore, at block 222, external system data provider 134 determines whether the API call is to send data to or receive data from external computing system 104. If the data access request is to retrieve data from data store 168, then external system accessing component 160 calls API 172 using the transformed data access request and obtains data in response to the call. It then provides the data to data transformation component 158 which preforms any low level transformations to transform the data into the native form, expected by data accessing system 122 and API 128. Receiving data responsive to the call in a form provided by external computing system 104 is indicated by block 224. Performing the low level transformation to transform the responsive data into a form expected by API 128 and data accessing system 122 is indicated by block 226. External system data provider 134 returns the data to the calling component using API 128. This is indicated by block 228.

It may be that the returned data may be operated on by synchronization system 124 as well. For instance, if certain pieces of computing system 102 expect the returned data to be in a specific form (e.g., to have three address fields instead of two), then system 124 can perform those types of transformations on the data before it is used by the other pieces of system 102.

It should be noted that, the lower level components discussed herein (e.g., external data provider 134) enable the upper level components to access external data as if it was in a native table. Therefore, the upper level processing components in computing system 102, can operate on the data, in the same way that they would operate on native data that is stored in native data store 132. For instance, synchronization system 124 can synchronize the data with data stored in native data store 132 or for use by any other prices of system 102. This is indicated by block 230. In addition, a search system or explorer in one of the upper level processing components can surface the data for user visualization and navigation. This is indicated by block 232. The data can be used to generate other user interface displays as indicated by block 234. Any of the upper level processing components (such as application functionality 140) can also perform logical operations on the data, as indicated by block 236. Report generation components can generate reports from the data as indicated by block 238, and the data can also be prepared for visualization on a variety of different client types. This is indicated by block 240.

For instance, it may be that computing system 102 supports access by web browser clients, mobile device clients, desktop clients, etc. The visualizations may be defined in metadata, and transformed into a desired visualization, based upon the particular client type. Because data is returned from external computing system 104 in a form that is the same as that provided by native data store 132, the data from system 104 can be visualized on all of the different client types supported by system 102. Of course, the data can be operated on in other ways as well, and this is indicated by block 242.

In another scenario, external data in computing system 168 can be accessed by computing system 102. The upper level processing components can then perform logical operations on that data, even if the data, itself, is not permanently stored on computing system 102. Instead, the results of the logical operations may either be used on computing system 102 or stored there, or they may be returned to computing system 104 and stored and used there. All of these types of scenarios are contemplated herein.

Returning to the flow diagram of FIG. 2, if at block 222, it is determined that data is to be transmitted to external computing system 104, instead of received therefrom, it is assumed that synchronization system 124 has performed any higher level transformations on the data so it is in a form that complies with the external schema of the corresponding record in computing system 104. The data access request to write the data to the data store 168 is provided to data accessing layer 122 and API 128 in the same way as if the data were to be written to a native table in native data store 132. Data transformation component 158 performs any low level transformations on the data. This is indicated by block 244. External system accessing component 160 then sends the data in the expected form, to data provider 170, through API 172. It thus provides the data to computing system 104, using the API 172 of computing system 102, according to a form or schema that is expected by computing system 104. Sending the data in this way is indicated by block 246.

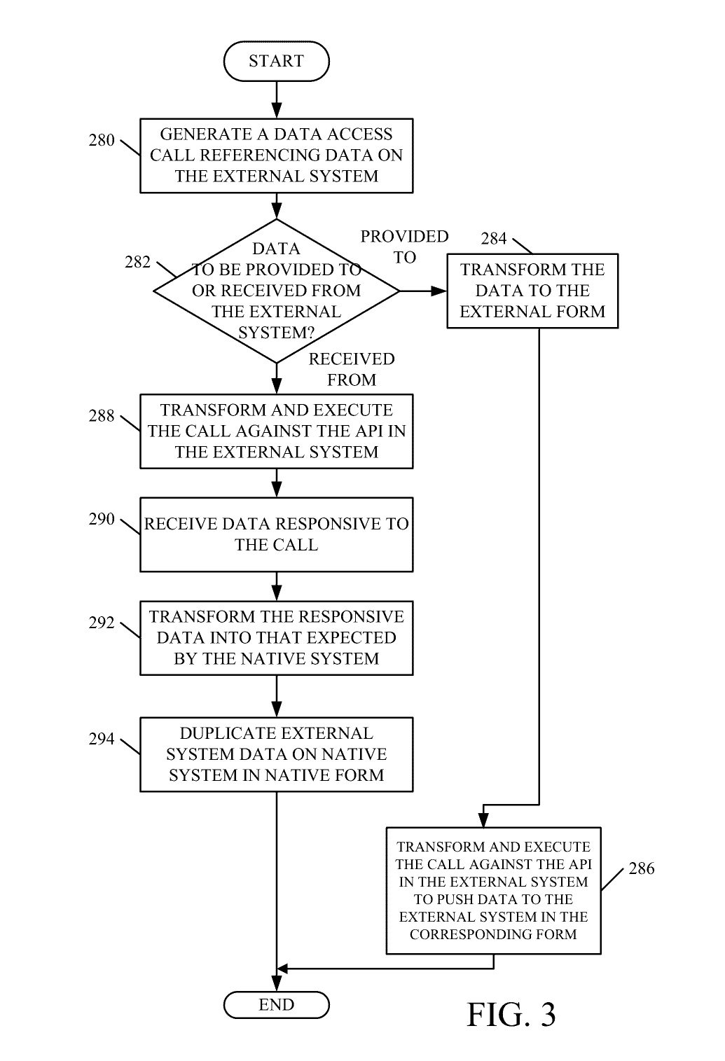

FIG. 3 is a flow diagram illustrating one example of the operation of synchronization system 124 shown in FIG. 1. FIG. 3 illustrates two scenarios. The first is where synchronization system 124 is synchronizing data from external computing system 104 with corresponding data in native data store 132, by obtaining data from external computing system 104 and duplicating it in native data store 132. The second scenario is where synchronization system 124 is synchronizing data by pushing data to data store 168 in external computing system 104. It will be appreciated that these are only two examples of how synchronization system 124 can work, and it can perform operations in a wide variety of other ways as well.

Synchronization system 124 first generates a data access call referencing data on external computing system 104. This is indicated by block 280 in FIG. 3. For instance, the call may be executed through data accessing system 122 and API 128 (as if it were to access data in native data store 132) and directed to external system data provider 134. The call may be to retrieve data from data store 168 in external computing system 104 or to push data to data store 168. Determining which operation is to be performed is indicated by block 282. If data is to be provided to external computing system 104, then data transformation component 158 first performs any low level transformations to transform the data to be provided, into a form expected by external computing system 104 and API 172. This is indicated by block 284.

Request transformation component 156 performs any remaining transformations on the data access request that are needed in order to comply with API 172, and external system accessing component 160 executes the API call against API 172. Data provider 134 thus pushes data to the external system 104 in the form expected by external computing system 104. This is indicated by block 286.

If, at block 282, it is determined that data is being sought from external computing system 104, then request transformation component 156 transforms the call into a form expected by API 172, and external system accessing component 160 then executes the transformed call against API 172. This is indicated by block 288. API 172 interacts with data provider 170 to retrieve the requested data from data store 168, and returns it to external system accessing component 160. Receiving data responsive to the call to API 172 is indicated by block 290 in FIG. 3. Data transformation component 158 then again performs any low level transformations to transform the responsive data into a form expected by API 128 (and hence expected by other components of the native computing system 102). This is indicated by block 292. The data is returned through API 128 and data accessing system 122 to synchronization system 124. Synchronization system 124 then illustratively duplicates the data from external system 104 on native data store 132, using native data provider 130. In doing so, system 124 illustratively performs any data transforming needed so the data is stored according to a native structure or native schema expected by native data store 132. Duplicating the data is indicated by block 294 in FIG. 3.

It can thus be seen that using external system data provider (or virtual data provider) 134 to provide data from an external system, the data can be transformed so that it is usable by all other components of computing system 102. By providing data provider 134 at the data provider level in the computing stack, this enables all upper level components in the computing stack (those above the data provider level) to treat or operate on external data (from external computing system 104) as if it were native data (from native data store 132). Thus, all of the components of data accessing system 122, synchronization system 124, and all of the other components of application component 118 and any other upper level computing systems or components can operate on the data as if it were native data.

Similarly, this enables synchronization system 124 to be moved fully onto computing system 102. This greatly enhances the flexibility of the computing system. Instead of providing a synchronization component that sits between computing systems 102 and 104 and attempts to synchronize data, synchronization system 124 can easily synchronize data, because it is synchronizing data that is provided in the form of only one of the computing systems, instead of both. Any customizations to data by either computing system 102 or computing system 104, can easily be accommodated by synchronization system 124.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

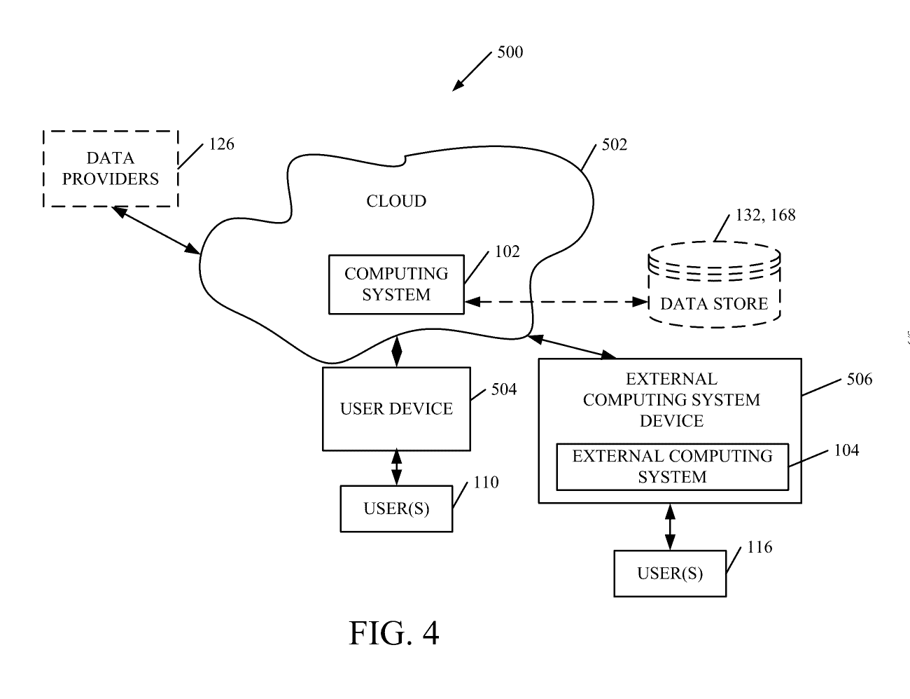

FIG. 4 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 4, some items are similar to those shown in FIG. 1 and they are similarly numbered. FIG. 4 specifically shows that system 102 can be located in cloud 502 (which can be public, private, or a combination where portions are public while others are private). Therefore, user 110 uses a user device 504 to access those systems through cloud 502. External system 104 can be deployed in cloud 502 or on an external system device 506.

FIG. 4 also depicts another example of a cloud architecture. FIG. 4 shows that it is also contemplated that some elements of architecture 100 can be disposed in cloud 502 while others are not. By way of example, data stores 132 or 168 can be disposed outside of cloud 502, and accessed through cloud 502. In another example, data providers 126 can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

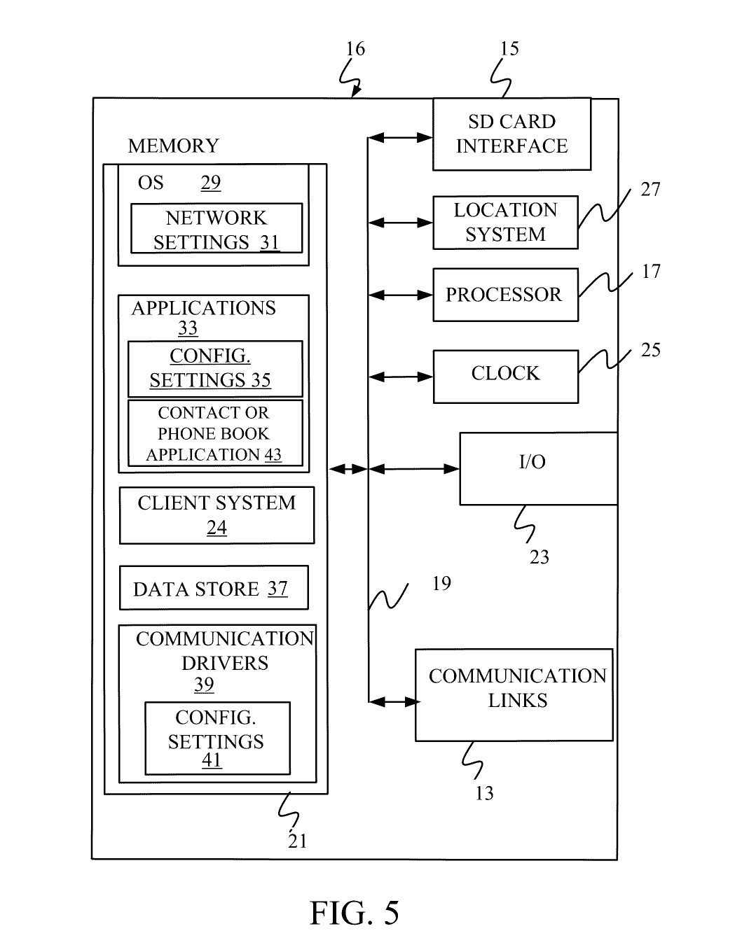

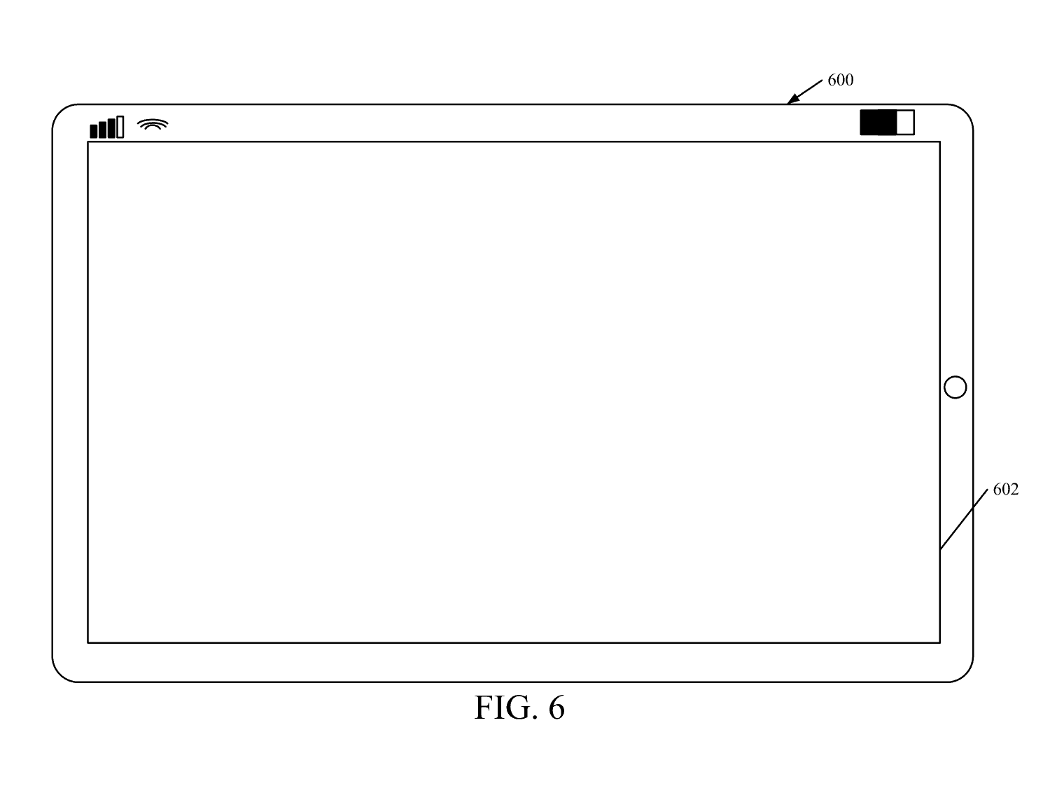

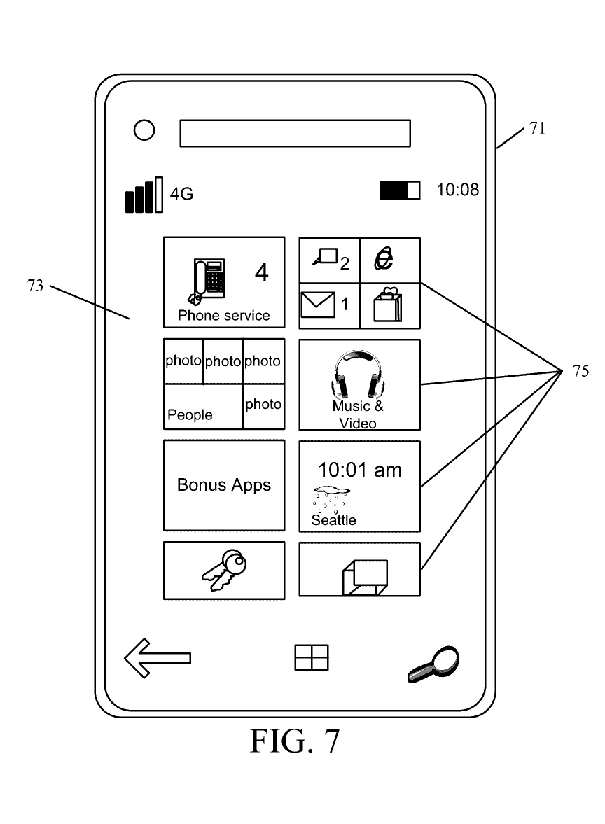

FIG. 5 is a simplified block diagram of one illustrative example of a handheld or mobile computing device that can be used as a user's or client's hand held device 16, in which the present system (or parts of it) can be deployed. FIGS. 6-7 are examples of handheld or mobile devices.

FIG. 5 provides a general block diagram of the components of a client device 16 that can run components of architecture 100 or that interacts with architecture 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as Wi-Fi protocols, and Bluetooth protocol, which provide local wireless connections to networks.

In other examples, applications or systems are received on a removable Secure Digital (SD) card that is connected to a SD card interface 15. SD card interface 15 and communication links 13 communicate with a processor 17 (which can also embody processors 120 or 174 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client system 24 which can run various business applications or embody parts or all of architecture 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one embodiment in which device 16 is a tablet computer 600. In FIG. 6, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used as well. Device 16 can be, a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1×rtt, and Short Message Service (SMS) signals. In some examples the phone also includes a Secure Digital (SD) card slot that accepts a SD card.

The mobile device can also be a personal digital assistant or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. The PDA can also include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 7 shows that the phone can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

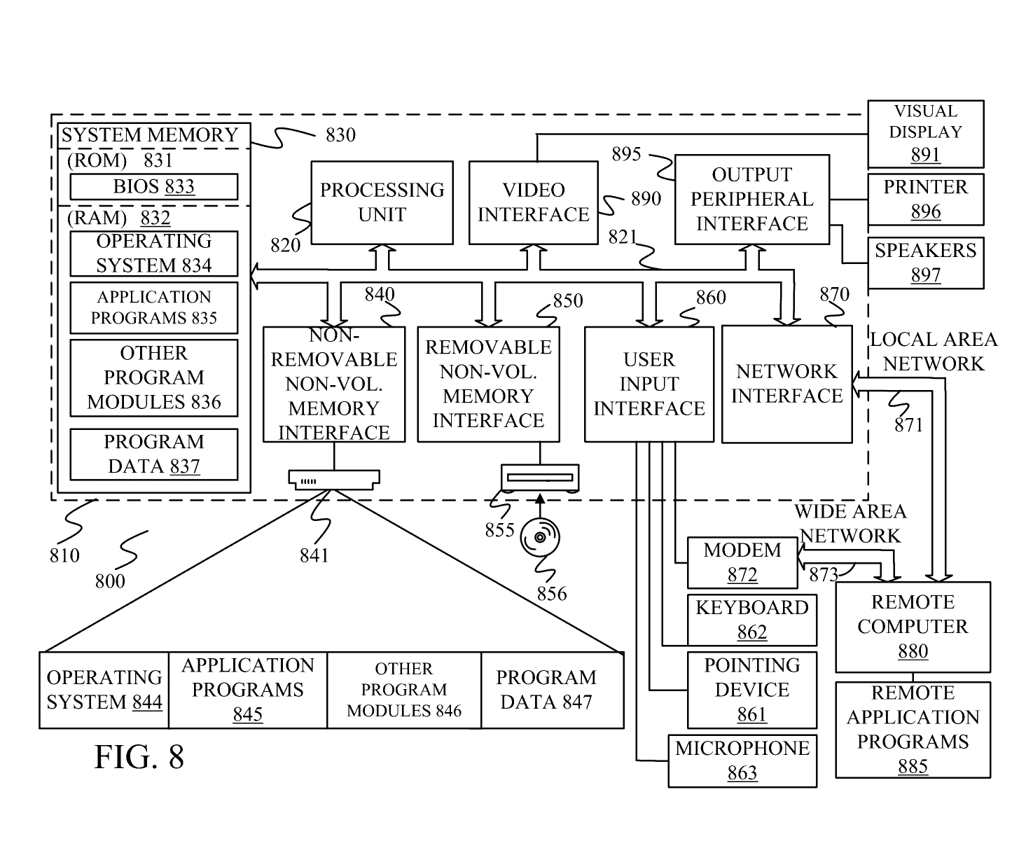

FIG. 8 is one example of a computing environment in which architecture 100, or parts of it, (for example) can be deployed. With reference to FIG. 8, an example system for implementing some embodiments includes a general-purpose computing device in the form of a computer 810. Components of computer 810 may include, but are not limited to, a processing unit 820 (which can comprise processor 120 or 174), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 8.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

a native data provider that exposes an application programming interface (API) to provide native data to a set of upper level computing elements; and

an external system data provider that exposes the API to provide external data, from an external computing system, to the upper level computing elements, the external system data provider converting a data access call to an external call to the external computing system and transforming the external data to provide the external data to the upper level computing elements through the API, in a native form that is a same form as the native data provided by the native data provider.

Example 2 is the computing system of any or all previous examples wherein the external system data provider comprises:

a request transformation component that transforms the data access call to a call consistent with an external API exposed by an external data provider that is native to the external computing system; and

an external system accessing component that executes the call against the external API.

Example 3 is the computing system of any or all previous examples wherein the external data is received by the external system data provider in an external form provided by the external computing system and wherein the external system data provider comprises:

a data transformation component that transforms the external data from the external form to the native form.

Example 4 is the computing system of any or all previous examples wherein the data access call comprises a call to save data to the external computing system and wherein the data transformation component transforms data to be saved to the external computing system from the native form to the external form.

Example 5 is the computing system of any or all previous examples wherein the request transformation component transforms the data access call to a call consistent with the external API to save the data to the external computing system.

Example 6 is the computing system of any or all previous examples and further comprising:

a synchronization system that receives the external data through the API, in the native form, and synchronizes it with corresponding native data.

Example 7 is the computing system of any or all previous examples and further comprising:

a data accessing system that accesses the native data and the external data through the API, from the native data provider and the external system data provider, and provides it to the upper level computing elements.

Example 8 is the computing system of any or all previous examples wherein the data accessing system comprises:

a data source identifier that identifies a data provider that is a target of the data access call.

Example 9 is the computing system of any or all previous examples wherein the data accessing system comprises:

a data source accessing component that executes the data access call against the data provider identified as the target of the data access call.

Example 10 is a computer implemented method, comprising:

exposing an application programming interface (API) on a native data provider to provide native data to a set of upper level computing elements;

exposing the API on an external system data provider to provide external data, from an external computing system, to the set of upper level computing elements;

receiving a data access call through the API exposed by the external system data provider;

converting the data access call to an external call to an external computing system;

receiving external data in response to the external call;

transforming the external data to a native form that is a same form as the native data provided by the native data provider; and

providing the external data, in the native form, to the upper level computing elements through the API.

Example 11 is the computer implemented method of any or all previous examples wherein converting the data access call to an external call comprises:

transforming the data access call to a call consistent with an external API exposed by an external data provider that is native to the external computing system.

Example 12 is the computer implemented method of any or all previous examples wherein the external data is received in an external form provided by the external computing system and wherein transforming the external data to a native form comprises:

transforming the external data from the external form to the native form.

Example 13 is the computer implemented method of any or all previous examples and further comprising:

receiving a data access call from an upper level computing element to save data to the external computing system; and

transforming data to be saved to the external computing system from the native form to the external form.

Example 14 is the computer implemented method of any or all previous examples wherein one of the upper level computing elements comprises a synchronization system and further comprising:

receiving the external data through the API, in the native form, at the synchronization system; and

synchronizing the external data with corresponding native data.

Example 15 is the computer implemented method of any or all previous examples and further comprising:

identifying a data provider that is a target of the data access call; and

executing the data access call against the data provider identified as the target of the data access call.

Example 16 is a computing system, comprising:

a native data provider that exposes a native application programming interface (API) to provide native data to a set of upper level computing elements; and

an external system data provider that exposes the native API to provide external data to the set of upper level computing elements, the external system data provider comprising:

a request transformation component that transforms a data access call from a given one of the set of upper level computing elements to a call consistent with an external API exposed by an external data provider that is native to an external computing system;

an external system accessing component that executes the transformed data access call against the external API and receives the external data in an external form provided by the external computing system; and

a data transformation component that transforms the external data from the external form to the native form and provides it through the native API to the given upper level computing element.

Example 17 is the computing system of any or all previous examples wherein a second data access call comprises a call to save data to the external computing system and wherein the data transformation component transforms data to be saved to the external computing system from the native form to the external form.

Example 18 is the computing system of any or all previous examples wherein the request transformation component transforms the second data access call to a call consistent with the external API to save the data, that is transformed to the external form, to the external computing system.

Example 19 is the computing system of any or all previous examples and further comprising:

a synchronization system that receives the external data through the native API, in the native form, and synchronizes it with corresponding native data through the native data provider.

Example 20 is the computing system of any or all previous examples and further comprising:

a data accessing system that accesses the native data and the external data through the native API, from the native data provider and the external system data provider, respectively, and provides it to the given upper level computing element, the data accessing system comprising:

a data source identifier that identifies a data provider that is a target of the data access call; and

a data source accessing component that executes the data access call against the data provider identified as the target of the data access call.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
a native data provider that exposes an application programming interface (API) to provide native data to a set of upper level computing elements; and
an external system data provider that exposes the API to provide external data, from an external computing system, to the upper level computing elements, the external system data provider converting a data access call to an external call to the external computing system and transforming the external data to provide the external data to the upper level computing elements through the API, in a native form that is a same form as the native data provided by the native data provider.

2. The computing system of claim 1 wherein the external system data provider comprises:
a request transformation component that transforms the data access call to a call consistent with an external API exposed by an external data provider that is native to the external computing system; and
an external system accessing component that executes the call against the external API.

3. The computing system of claim 2 wherein the external data is received by the external system data provider in an external form provided by the external computing system and wherein the external system data provider comprises:
a data transformation component that transforms the external data from the external form to the native form.

4. The computing system of claim 3 wherein the data access call comprises a call to save data to the external computing system and wherein the data transformation component transforms data to be saved to the external computing system from the native form to the external form.

5. The computing system of claim 4 wherein the request transformation component transforms the data access call to a call consistent with the external API to save the data to the external computing system.

6. The computing system of claim 3 and further comprising:
a synchronization system that receives the external data through the API, in the native form and in an external schema, and synchronizes it with corresponding native data in a native schema.

7. The computing system of claim 4 and further comprising:
a data accessing system that accesses the native data and the external data through the API, from the native data provider and the external system data provider, and provides it to the upper level computing elements.

8. The computing system of claim 7 wherein the data accessing system comprises:
a data source identifier that identifies a data provider that is a target of the data access call.

9. The computing system of claim 8 wherein the data accessing system comprises:
a data source accessing component that executes the data access call against the data provider identified as the target of the data access call.

10. A computer implemented method, comprising:
exposing an application programming interface (API) on a native data provider to provide native data to a set of upper level computing elements;
exposing the API on an external system data provider to provide external data, from an external computing system, to the set of upper level computing elements;
receiving a data access call through the API exposed by the external system data provider;
converting the data access call to an external call to an external computing system;
receiving external data in response to the external call;
transforming the external data to a native form that is a same form as the native data provided by the native data provider; and
providing the external data, in the native form, to the upper level computing elements through the API.

11. The computer implemented method of claim 10 wherein converting the data access call to an external call comprises:
transforming the data access call to a call consistent with an external API exposed by an external data provider that is native to the external computing system.

12. The computer implemented method of claim 11 wherein the external data is received in an external form provided by the external computing system and wherein transforming the external data to a native form comprises:
transforming the external data from the external form to the native form.

13. The computer implemented method of claim 11 and further comprising:
receiving a data access call from an upper level computing element to save data to the external computing system; and
transforming data to be saved to the external computing system from the native form to the external form.

14. The computer implemented method of claim 12 wherein one of the upper level computing elements comprises a synchronization system and further comprising:
receiving the external data through the API, in the native form according to an external schema, at the synchronization system; and
synchronizing the external data with corresponding native data in a native schema.

15. The computer implemented method of claim 12 and further comprising:
identifying a data provider that is a target of the data access call; and
executing the data access call against the data provider identified as the target of the data access call.

16. A computing system, comprising:
a native data provider that exposes a native application programming interface (API) to provide native data to a set of upper level computing elements; and
an external system data provider that exposes the native API to provide external data to the set of upper level computing elements, the external system data provider comprising:
a request transformation component that transforms a data access call from a given one of the set of upper level computing elements to a call consistent with an external API exposed by an external data provider that is native to an external computing system;
an external system accessing component that executes the transformed data access call against the external API and receives the external data in an external form provided by the external computing system; and
a data transformation component that transforms the external data from the external form to the native form and provides it through the native API to the given upper level computing element.

17. The computing system of claim 16 wherein a second data access call comprises a call to save data to the external computing system and wherein the data transformation component transforms data to be saved to the external computing system from the native form to the external form.

18. The computing system of claim 17 wherein the request transformation component transforms the second data access call to a call consistent with the external API to save the data, that is transformed to the external form, to the external computing system.

19. The computing system of claim 16 and further comprising:
a synchronization system that receives the external data through the native API, in the native form and according to an external schema, and synchronizes it with corresponding native data through the native data provider according to a native schema.

20. The computing system of claim 16 and further comprising:
a data accessing system that accesses the native data and the external data through the native API, from the native data provider and the external system data provider, respectively, and provides it to the given upper level computing element, the data accessing system comprising:
a data source identifier that identifies a data provider that is a target of the data access call; and
a data source accessing component that executes the data access call against the data provider identified as the target of the data access call.
